(19) United States
(12) Patent Application Publication
(10) Pub. No.: US 2007/0187371 A1
(43) Pub. Date: Aug. 16, 2007

(54) STRUCTURAL COMPONENT FOR A MOTOR VEHICLE

(75) Inventor: Hans-Jurgen Knaup, Bad Lippspringe (DE)

Correspondence Address: Henry M. Feiereisen;Henry M. Feiereisen, LLC, Suite 4714, 350 Fifth Avenue, New York, NY, 10118, US

(73) Assignee: Benteler Automobiltechnik GmbH, Paderborn (DE)

(21) Appl. No.: 11/671,674

(22) Filed: Feb. 6, 2007

(30) Foreign Application Priority Data
Feb. 14, 2006 (DE) 10 2006 006 955.2

(51) Int. Cl. B23K 11/00

(52) U.S. Cl. 219/117.1

(57) ABSTRACT

A structural component for a motor vehicle, such as a center pillar or bumper cross member, includes comprising a plurality of metal sheets joined together by welding spots. At least one of the metal sheets is provided with relief zones in an area between the welding spots, with the relief zones being formed by recesses in the metal sheet.

### CROSS-REFERENCES TO RELATED APPLICATIONS

This application claims the priority of German Patent Application, Serial No. 10 2006 006 955.2, filed Feb. 14, 2006, pursuant to 35 U.S.C. 119(a)-(d), the content of which is incorporated herein by reference in its entirety as if fully set forth herein.

### BACKGROUND OF THE INVENTION

The present invention relates, in general, to a structural component for a motor vehicle.

Nothing in the following discussion of the state of the art is to be construed as an admission of prior art.

Structural components made of metal sheets are typically connected by means of spot welding, using two electrodes between which the metal sheets to be joined are compressed. A high current is conducted briefly from one electrode through the metal sheets to the other electrode. The required welding temperature is generated as a result of the substantial electric resistance between the metal sheets. A typical lens-shaped spot welding is realized by matching force, current and welding time patterns to one another.

Spot-welded structural components, such as, e.g., center pillars with cover plates and reinforcements oftentimes fail as a result of cracks originating in regions that have been weakened by the spot welding operation. This is especially a concern in the event of a crash.

It would therefore be desirable and advantageous to provide an improved structural component for a motor vehicle to obviate prior art shortcomings and to exhibit better stress behavior and reliability.

### SUMMARY OF THE INVENTION

According to one aspect of the present invention, a structural component for a motor vehicle includes a plurality of metal sheets which are joined together by welding spots, wherein at least one of the metal sheets is provided with relief zones in an area between the welding spots, with the relief zones being formed by recesses in the metal sheet.

The present invention resolves prior art problems by providing relief zones by which stress peaks in regions weakened by spot welding are reduced. The relief zones cause the stress in the structural component and thus the expansion to be evenly distributed. As a result, a structural part according to the present invention exhibits a much better stress behavior. This has a positive effect when the structural component is used in a motor vehicle and upon encountering static and dynamic loads. In the event of a crash, the structural component is able to absorb more impact energy and have a much reduced tendency for failure.

According to another feature of the present invention, the recesses may be open toward an edge of the metal sheet. In the area between two welding spots, the metal sheet is trimmed away is such a way that the stress and thus expansion are evenly spread across the structural component.

A structural component according to the present invention can be used as the center pillar or B-pillar of a motor vehicle or as the bumper cross member. When intended for use as the center pillar, one of the metal sheets has a cup-shaped configuration and is closed by the other metal sheet which forms a cover plate. Optionally, reinforcements may be incorporated in the center pillar.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of a section of a structural component according to the present invention for use in a motor vehicle; and

FIG. 2 is a detailed cutaway view of the structural component, showing a region between two welding spots.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

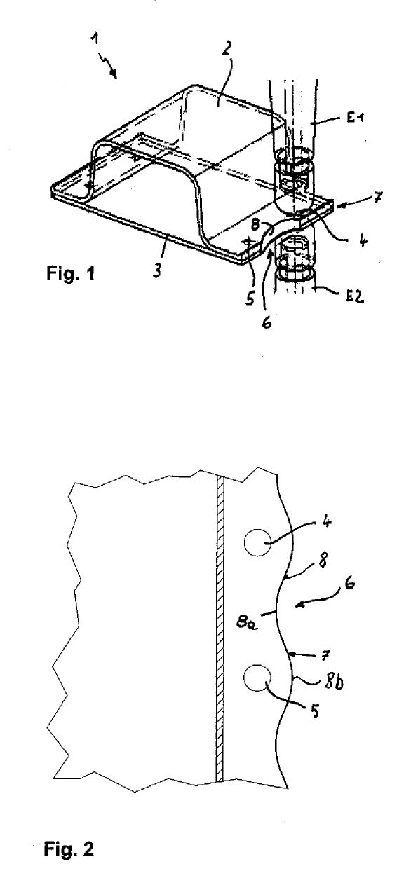

Turning now to the drawing, and in particular to FIG. 1, there is shown a perspective illustration of a section of a structural component according to the present invention, generally designated by reference numeral 1, for use in a motor vehicle. The structural component 1 is illustrated here by way of example and involves the configuration for a center pillar for a motor vehicle. The structural component 1 is essentially made of a metal sheet 2 having a cup-shaped configuration, and a metal sheet 3 which forms a cover plate to close the metal sheet 2.

The metal sheets 2, 3 are joined together by welding spots 4, 5. Reference signs E1, E2 designate electrodes by which the cup-shaped metal sheet 2 and the metal sheet 3 can be spot welded. FIG. 2 shows a detailed cutaway view of the structural component 1, depicting a region between the two welding spots 4, 5.

In order to reduce stress peaks in the regions that have been weakened, relief zones 6 are provided in the area between the welding spots 4, 5. The relief zones 6 are realized by trimming the metals sheets 2, 3 such as to inwardly form a recess 8 which is open to the edge side 7 of the metal sheets 2, 3 so that stress and thus expansion are evenly distributed across the structural component 1. In other words, the edge 7 of the metal sheets 2, 3 is cut to exhibit a waveform with peaks and valleys, whereby a valley 8a is positioned between the welding spots 4, 5 while the peaks 8b are positioned in the area of the welding spots 4, 5.

The targeted incorporation of recesses 8 along the edge 7 counteracts a crack formation in these zones. Moreover, stress behavior of the structural component 1 can be best suited during operation of the motor vehicle. The relief zones 6 affect the force pattern within the structural components 1 in the event of an external force impact during a collision and cause the forces and thus expansions to evenly spread across the structural component 1. As a result, the energy absorption capability of the structural component is increased.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A structural component for a motor vehicle, comprising a plurality of metal sheets joined together by welding spots, wherein at least one of the metal sheets is provided with relief zones in an area between the welding spots, said relief zones being formed by recesses in the metal sheet.

2. The structural component of claim 1, wherein the recesses are open toward an edge of the metal sheet.

3. The structural component of claim 1, wherein one of the metal sheets has a cup-shaped configuration, with another metal sheet forming a cover plate to close the one metal sheet.

4. The structural component of claim 1, for application as a center pillar.

5. The structural component of claim 1, for application as a bumper cross member.

6. A structural component for a motor vehicle, comprising first and second metal sheets joined together by welding spots, wherein at least one of the first and second metal sheets is provided with a relief zone in an area between two successive ones of the welding spots, said relief zone being formed by at least one recess in the one of the first and second metal sheets.

7. The structural component of claim 6, wherein the recess is open toward an edge of the metal sheet.

8. The structural component of claim 6, wherein one of the first and second metal sheets has a cup-shaped configuration, with the other one of the first and second metal sheets forming a cover plate to close the one of the first and second metal sheets.

9. The structural component of claim 6, for application as a center pillar.

10. The structural component of claim 6, for application as a bumper cross member.

11. A structural component for a motor vehicle, comprising first and second metal sheets joined together by welding spots, wherein at least one of the first and second metal sheets has an edge which is constructed of waveform configuration, defining peaks and valleys, wherein a valley is positioned between two successive ones of the welding spots and peaks are positioned adjacent to the welding spots.

12. The structural component of claim 11, wherein the valley is positioned in midsection between the welding spots.

13. The structural component of claim 11, wherein one of the first and second metal sheets has a cup-shaped configuration, with the other one of the first and second metal sheets forming a cover plate to close the one of the first and second metal sheets.

14. The structural component of claim 11, for application as a center pillar.

15. The structural component of claim 11, for application as a bumper cross member.
